(19) United States
(12) Patent Application Publication
(10) Pub. No.: US 2024/0386296 A1
(43) Pub. Date: Nov. 21, 2024

(54) SYSTEM AND METHOD FOR TEACHING MACHINE LEARNING MODELS TO RECOGNIZE CONCEPTS IN MULTIMEDIA DOCUMENTS THROUGH NATURAL LANGUAGE INTERACTION AND MIXED-INITIATIVE LEARNING

(71) Applicant: LAER AI, Inc., New York, NY (US)

(72) Inventor: Igor LABUTOV, New York, NY (US)

(73) Assignee: LAER AI, Inc., New York, NY (US)

(21) Appl. No.: 18/667,896

(22) Filed: May 17, 2024

Related U.S. Application Data
(60) Provisional application No. 63/503,346, filed on May 19, 2023.

(51) Int. Cl. G06N 5/04; G06N 5/022

(52) U.S. Cl. CPC G06N 5/04; G06N 5/022

(57) ABSTRACT

A method and system for training machine learning models using natural language interactions as well as techniques utilizing machine learning models trained using natural language interactions. A method includes applying a language model to text of a set of natural language interactions in order to output a set of domain-specific language (DSL) data, wherein the set of natural language interactions is between a user and at least one other entity, wherein the set of natural language interactions indicates at least one user-defined concept; querying a knowledge base based on the set of DSL data in order to obtain at least one DSL query result; integrating the at least one DSL query result with a structured representation of the natural language interactions in order to create at least one contextualized DSL query result; and training the language model using the at least one contextualized DSL query result.

### CROSS-REFERENCE TO RELATED APPLICATIONS

This application claims the benefit of U.S. Provisional Application No. 63/503,346 filed on May 19, 2023, the contents of which are hereby incorporated by reference.

### TECHNICAL FIELD

The present disclosure relates generally to training machine learning models, and more specifically to training machine learning models through natural language interactions.

### BACKGROUND

The current legal pipeline, encompassing corporate, investigation, and litigation settings, is beset with numerous challenges and inefficiencies. These environments often classify documents according to bespoke concepts specific to a corporation or task, using either rules (e.g., keyword-based rules) or datasets for training machine learning models. Contemporary tools, however, demand user proficiency and typically employ a single way of training the system, either requiring users to provide labeled examples of documents that do and do not match the concept, or requiring them to provide decision rules such as Boolean queries.

An example of these issues is found in litigation, governance, and compliance. In an example governance/compliance scenario, a corporation hires a team of compliance experts using dedicated tools combining keyword searches and machine learning from examples. These experts devise search terms to identify content violating corporate governance rules or regulatory requirements, in order to avoid litigation. In some cases, the experts may also tag example cases of violations to train machine learning models for automatic identification.

Eventually, violations may lead to litigation, prompting the export of corporate data to a law firm. This firm employs document reviewers to find substantiating documents for the legal case against the corporation, which often resemble searches conducted by corporate compliance experts. Throughout litigation, other team members, such as associates and partners, refine the data found by document reviewers for use during later stages, like deposition and trial prep.

However, the knowledge amassed during litigation is not utilized to enhance machine learning models and inform corporate compliance/governance experts. This valuable information, capable of improving corporate data governance and document review, is effectively discarded due to limited communication between different groups of experts using different tools. Two potential reasons for this situation are: (1) corporations and law firms using different tools; and (2) corporations and law firms employing different experts for tasks ranging from governance to document review to depositions.

As a result, information flows linearly through the process, and most of it remains inaccessible until processed by the previous stage. This generates three notable consequences: (1) time delays; (2) communication barriers due to different tools; and 3) error propagation.

As to time delays, human effort at each stage slows information propagation, causing changes to the data to take time to reach later stages. For example, a change in the Request for Production takes time to affect the Document Review Protocol, and reviewers need time to find new documents accordingly. Consequently, associates prepping for a deposition may not access the most relevant documents at crucial moments.

As to communication barriers, the use of various tools and experts at different legal work stages creates communication barriers, leading to compartmentalization and expertise bubbles. For instance, when associates obtain new information during a deposition, they typically lack the training or resources to use document reviewers' tools to add information by tagging additional documents. Similarly, corporate compliance and governance experts employ different tools, making it difficult for predictive models built during litigation to be shared or adapted in a timely manner. This prevents effective knowledge transfer about legal issues accumulated during litigation for future risk minimization.

As to error propagation, current tools for litigation and compliance/governance primarily include keyword searches and machine learning-based predictive tools that learn from tagged document examples. These tools introduce the likelihood of error, either Type 1 (false positive) or Type 2 (false negative) errors. As the current workflow progresses linearly from compliance/governance to early-case assessment, document review, and depositions, errors accumulate at each stage.

Legal tasks, from compliance/governance to early-case assessment, document review, and deposition, share at least a few attributes: (1) bespoke specifications; (2) natural language; and (3) dynamic specifications/queries.

As to bespoke specifications, unique specifications defining the information needed to be identified are required for every corporation as part of standard governance and compliance due diligence. Each one comes with their own guidelines, rules for governance, and changing government regulations.

As to natural language, currently, bespoke specifications are often specified in natural language for experts implementing them today, with varying types of documents and people involved in communication.

As to dynamic specification/queries, the process for specifying specifications is often dynamic, highly interactive, and intertwined with querying the data obtained by applying those specifications. Specification and querying evolve over time and across the organization. Initial specifications lead to initial results, which other team members use to reformulate or extend the specifications. This takes the form of constant back-and-forth communication between team members at different stages of the pipeline.

Some challenges and barriers created by some existing solutions utilized in these legal processes include: (1) pipeline workflows limit and slow information sharing; and (2) inflexible narrow tools hinder knowledge specification and queries.

As to pipeline workflows, information propagates linearly through the process, with each stage employing dedicated experts using narrowly-focused tools. New information gained at later stages does not easily or quickly propagate to earlier stages to update specifications. Experts must communicate ad hoc, leading to slow information propagation and limited changes to specifications based on new information. Associates cannot directly enter new information into the system; they must communicate with other pipeline members.

As to inflexible narrow tools, some existing solutions target narrow expertise and is not universally used by everyone involved in the legal process. Different experts must communicate to request specific changes to specifications or formulate query requests for information. However, even this is problematic, as current tools support limited interaction types. For teaching new information, existing tools can only learn from many examples of the desired new information. For specifying new information in the form of updated specifications, reviewers may need to tag new examples to update machine learning models, which can be laborious and time-consuming. For querying, most queries are formulated through Boolean searches, which are highly narrow and precise but often miss many relevant documents.

FIG. 4 is an example illustration 400 showing a legal workflow in accordance with some existing solutions. Early case assessment is performed by attorneys and litigation analysis crafting keyword search filters used to identify relevant documents. Document review is typically performed by another group of document reviewers who perform manual review of many documents in order to discover potentially relevant documents. Documents discovered during document review are utilized during proceedings such as depositions. Compliance reviewers continually manually review internal documents to identify and flag risks.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for training a machine learning model using natural language interactions. The method comprises: applying a language model to text of a set of natural language interactions in order to output a set of domain-specific language (DSL) data, wherein the set of natural language interactions is between a user and at least one other entity, wherein the set of natural language interactions indicates at least one user-defined concept; querying a knowledge base based on the set of DSL data in order to obtain at least one DSL query result; integrating the at least one DSL query result with a structured representation of the natural language interactions in order to create at least one contextualized DSL query result; and training the language model using the at least one contextualized DSL query result.

Certain embodiments disclosed herein also include a non-transitory computer readable medium having stored thereon causing a processing circuitry to execute a process, the process comprising: applying a language model to text of a set of natural language interactions in order to output a set of domain-specific language (DSL) data, wherein the set of natural language interactions is between a user and at least one other entity, wherein the set of natural language interactions indicates at least one user-defined concept; querying a knowledge base based on the set of DSL data in order to obtain at least one DSL query result; integrating the at least one DSL query result with a structured representation of the natural language interactions in order to create at least one contextualized DSL query result; and training the language model using the at least one contextualized DSL query result.

Certain embodiments disclosed herein also include a system for training a machine learning model using natural language interactions. The system comprises: a processing circuitry; and a memory, the memory containing instructions that, when executed by the processing circuitry, configure the system to: applying a language model to text of a set of natural language interactions in order to output a set of domain-specific language (DSL) data, wherein the set of natural language interactions is between a user and at least one other entity, wherein the set of natural language interactions indicates at least one user-defined concept; querying a knowledge base based on the set of DSL data in order to obtain at least one DSL query result; integrating the at least one DSL query result with a structured representation of the natural language interactions in order to create at least one contextualized DSL query result; and training the language model using the at least one contextualized DSL query result.

Certain embodiments disclosed herein include the method, non-transitory computer readable medium, or system noted above, further including or being configured to perform the following step or steps: creating the structured representation of the set of natural language interactions, wherein the structured representation includes a set of fields and corresponding values, wherein the values in the structured representation include values represented in the natural language interactions.

Certain embodiments disclosed herein include the method, non-transitory computer readable medium, or system noted above, further including or being configured to perform the following step or steps: creating the knowledge base based on a dataset associated with a set of files, wherein the created knowledge base indicates a plurality of entities and a plurality of relationships between entities of the plurality of entities indicated among the set of files.

Certain embodiments disclosed herein include the method, non-transitory computer readable medium, or system noted above, wherein the at least one contextualized DSL query result indicates at least one of the plurality of entities.

Certain embodiments disclosed herein include the method, non-transitory computer readable medium, or system noted above, further including or being configured to perform the following step or steps: updating the knowledge base on at least a portion of the natural language interactions, wherein updating the knowledge base includes adding a representation of a new entity indicated in the portion of the natural language interactions.

Certain embodiments disclosed herein include the method, non-transitory computer readable medium, or system noted above, wherein the representation of the new entity added to the knowledge base is expressed in the domain-specific language.

Certain embodiments disclosed herein include the method, non-transitory computer readable medium, or system noted above, wherein the natural language interactions indicate at least one specification for the at least one user-defined concept.

Certain embodiments disclosed herein include the method, non-transitory computer readable medium, or system noted above, wherein the natural language interactions include at least one natural language query.

Certain embodiments disclosed herein include the method, non-transitory computer readable medium, or system noted above, further including or being configured to perform the following step or steps: applying the trained language model to at least one electronic document in order to identify at least one of the at least one user-defined concept in the at least one electronic document.

Certain embodiments disclosed herein include the system noted above, further including: the knowledge base (KB) storing entities, relations, and concepts; a natural language processing (NLP) component configured to translate the at least one natural language query into the at least one DSL query, wherein the natural language processing component includes the natural language processing model; a structured domain-specific language (DSL) component configured to query the knowledge base using the at least one DSL query; and a synthesis component configured to integrate the at least one knowledge base query result with the structured representation of the natural language interactions.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for training machine learning models using natural language interactions according to an embodiment.

FIG. 3 is a schematic diagram of a trainer according to an embodiment.

FIG. 4 is an example diagram of a legal workflow.

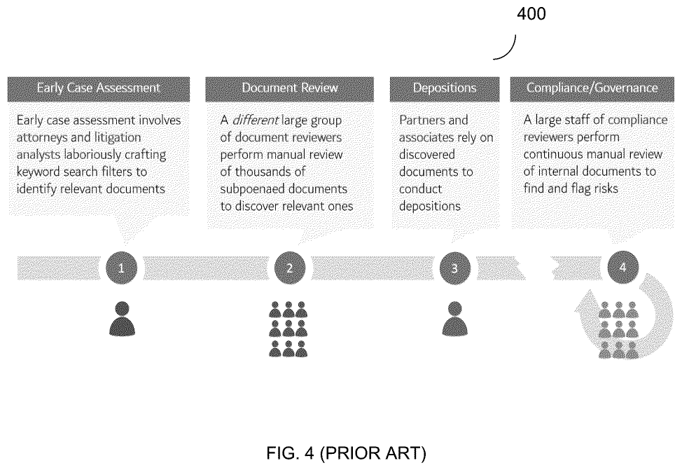

FIG. 5 is an example diagram of a workflow which may be realized in accordance with various disclosed embodiments.

FIG. 6 is an example diagram of a systems flow.

FIG. 7 is a table utilized to describe certain use cases involving mixed concept or strategy teaching which may be realized in accordance with various disclosed embodiments.

FIG. 8 is an example diagram illustrating a data flow for a process of training a machine learning model using natural language interactions.

FIG. 9 is an example diagram illustrating creation of a structured representation.

### DETAILED DESCRIPTION

In light of the challenges noted above, solutions which allow for improving existing workflows would be desirable. It has been identified that automated solutions for improving such workflows would be particularly desirable. However, the manual existing solutions cannot be automated simply by performing the same process via a computer. Accordingly, the disclosed embodiments provide solutions which allow for effectively automating these workflows by leveraging machine learning models in a process which overcomes various technical challenges to realizing this automation. More specifically, various disclosed embodiments enable training machine learning models to recognize concepts in data such as multimedia documents using natural language interactions. These natural language interactions may allow for bridging the gap between human teaching and machine learning without requiring management of the process by data scientists.

The various disclosed embodiments include methods and systems for training machine learning models using natural language interactions as well as techniques utilizing machine learning models trained using natural language interactions. The disclosed embodiments may be utilized to train machine learning models to identify concepts taught by users via natural language interactions with respect to electronic documents (also referred to as documents) such as, but not limited to, documents containing multimedia content. Such documents may be or may be based on documents created digitally based on user inputs (e.g., electronic documents created in word processor or image processing programs), or may represent real-world documents such as by including scanned images of real-world documents for which text may be identified, for example, using optical character recognition (OCR) techniques.

One benefit of at least some disclosed embodiments includes enabling untrained users to seamlessly engage with a unified system. In an embodiment, the system allows users to: (1) teach the system to a wide range of custom concepts that are applicable to different use-cases (e.g., use-cases in compliance, governance, litigation, investigation, and general corporate data management); (2) query knowledge, including concepts that were previously taught by other users of the system; and (3) interact in natural language, enabling users to teach and query knowledge through mixed-initiative natural language dialogue, as well as to communicate meta-knowledge and tasks related to the system itself, such as its performance. In some embodiments, queries can include searches over documents tagged with certain concepts, or composite queries such as documents that are tagged with certain concepts, constrained by other criteria, such as their content.

In an embodiment, the system is designed to communicate naturally and directly with different users across all stages of a process. It supports mixed-initiative interactions, allowing users to query the system in natural language. The system can also initiate interactions by asking questions or presenting new information. Types of natural language interactions the system may support include, but are not limited to: (1) teaching new knowledge; (2) querying knowledge; and (3) meta-level interactions.

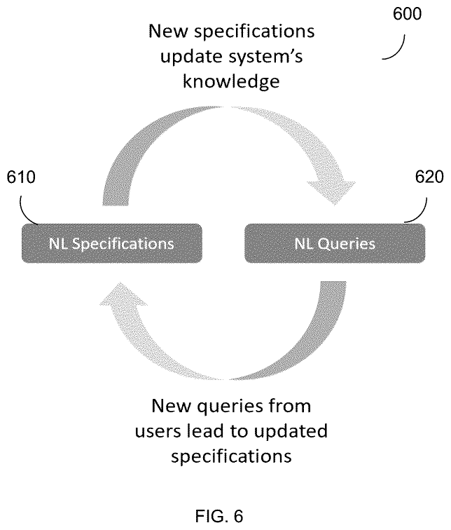

Teaching new knowledge may include, but is not limited to, receiving user inputs such as input specifications in the form of natural language descriptions or instructions, which are utilized in order to understand specific issues or specifications. The system may be configured to conduct dialogue with the user to clarify the information, ask for examples, and present found information, all through natural language dialogue. The taught concepts may include, but are not limited to, document-level, intra-document, and inter-document concepts. A non-limiting example of a system flow is described further below with respect to FIG. 6.

Document-level concepts may include, but are not limited to, classification categories applied to entire documents. As a non-limiting example for a legal implementation, such classification categories may include classification categories indicating that a given document is privileged or is responsive to a particular issue in the specification document.

Intra-document concepts may include, but are not limited to, concepts that are sub-document level, such as specific facts or information specified within documents. As a non-limiting example for a legal implementation, such intra-document concepts may include certain types of private information (PII) or certain types of information contained within documents, such as parameters of contacts, invoices, and other types of documents.

Inter-document concepts may include, but are not limited to, broad concepts that are not tied to documents but contain elements substantiated by documents or within documents. As a non-limiting example for a legal implementation, lists of lawyers or people involved in a particular transaction may not all be known prior to the case, but their names, titles, and roles are mentioned across many documents that serve as evidence and may therefore be utilized as inter-document concepts. The system can learn to extract facts like these. Such inter-document concepts may be represented between pairs of documents or within a given document.

Broad concepts may include events which may be represented across many (e.g., three or more) documents, multiple types of documents (e.g., one or more first types of documents and one or more second types of document, etc.). As a non-limiting example, a broad concept may be a financing event supported by various documents such as term sheets and closing sets.

As to querying knowledge, in an embodiment, users can query both newly taught knowledge and existing knowledge in the data (e.g., case data) through natural language inputs in the form of questions. As to meta-level interactions, the system may be configured to handle interactions involving issues surrounding the process itself, such as querying the system's predictive performance, querying the status of data in a workflow pipeline (e.g., a litigation pipeline), and specifying instructions for annotation.

In some embodiments, a system may include, but is not limited to, the following components: (1) a knowledge base (KB); (2) a structured domain-specific language (DSL) component configured to query knowledge in the knowledge base using domain-specific language queries and to update the knowledge base using data in the domain-specific language; (3) a natural language processor or other natural language processing (NLP) component configured to translate natural language queries and conversion context into domain-specific language, for example by applying a natural language processing model trained to text of a set of natural-language interactions; and (4) a synthesis component configured to integrate the result of executing domain-specific language over knowledge base into contextual data in the form of a structured representation of the natural language interactions to be utilized for training the natural language processing model for generating natural language responses to user's natural language queries.

In some embodiments, the system operates sequentially in a series of stages. In a further embodiment, at a first stage, initial data is imported into the system. The initial data may include, but is not limited to, text data, image data, video data, audio data, meta-data, or a combination thereof, associated with files. At a second stage, the system performs a pass over the data to build an internal Knowledge Base (KB) of base entities and relations, including of people, places, organizations, and relations such as employment, titles, and positions. The system, however, is not limited to extracting only this set of entity and relation types. New entities and relations may be taught by the user at a later stage. At a third stage, following initial data processing, the system becomes active and supports asynchronous natural language interactions from users.

The natural language interactions may include, but are not limited to: (1) specifications of concepts to be taught, (2) natural language queries, both, and the like. The specification natural language interactions include interactions where users can submit specifications through a conversational chat interface or by submitting a document containing the specifications, such as a document review protocol or an internal rulebook. During natural language query interactions, users can submit natural language queries in the form of questions. These questions may include or be related to facts in the data, document queries, concept queries, and meta-queries.

Examples of different types of concepts a user may teach in accordance with various disclosed embodiments include: (1) document-level concepts; (2) inter-document level concepts; and (3) intra-document level concepts. Document-level concepts teach that certain documents are instances of a given concept, with these concepts grounded in the contents of a single document. Inter-document level (spans) concepts teach that certain text spans or mentions are instances of a given concept (e.g., PII), with these concepts grounded in the contents of a given span/mention. Intra-document level concepts teach concepts that are not directly grounded in a single span or mention, but have attributes that may be grounded in multiple documents or texts.

The disclosed embodiments may be utilized to teach machine learning models for implementations such as, but not limited to, legal processes. As a non-limiting example, the disclosed embodiments may be utilized to enable users to engage seamlessly with a unified system from various stages of the legal process such as, but not limited to, compliance, governance, litigation, investigation, and general corporate data management.

In a non-limiting example implementation, the system functions as a hub among all stages of the legal process, from governance/compliance to litigation. In an embodiment, each stage of a process contributes and queries knowledge from a central unified system that persists and grows the knowledge, making it accessible to all expert groups across the entire litigation process.

It should be noted that the disclosed embodiments are not necessarily limited to legal implementations, and that the disclosed embodiments may be equally utilized for other implementations without departing from the scope of the disclosure. Various disclosed embodiments are discussed with respect to legal process implementations for example purposes and without limiting at least some disclosed embodiments.

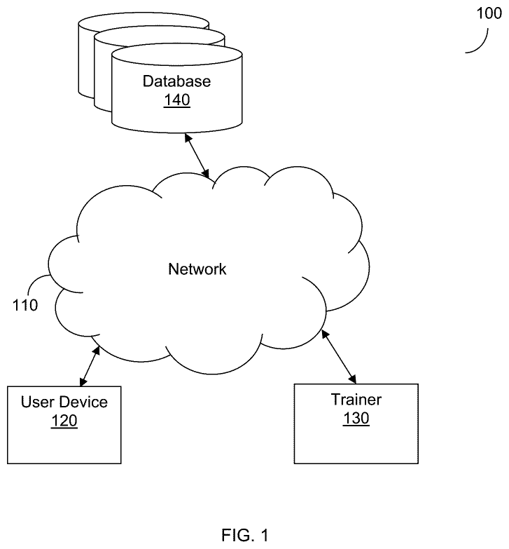

FIG. 1 shows an example network diagram 100 utilized to describe the various disclosed embodiments. In the example network diagram 100, a user device 120, a trainer 130, and a plurality of databases 140-1 through 140-N(hereinafter referred to individually as a database 140 and collectively as databases 140, merely for simplicity purposes) communicate via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The user device (UD) 120 may be, but is not limited to, a personal computer, a laptop, a tablet computer, a smartphone, a wearable computing device, or any other device capable of receiving indicating natural language inputs such as, but not limited to, text, audio, and the like. To this end, the user device 120 may include or communicate with one or more input devices such as, but not limited to, keyboards, mice, touch screens, microphones, combinations thereof, and the like, configured to capture natural language inputs from user.

The trainer 130 is configured to train machine learning models in accordance with various disclosed embodiments and, in some embodiments, may be further configured to utilize machine learning models.

The databases 140 store data to be utilized in training machine learning models such as, but not limited to, example documents, concepts taught by users, combinations thereof, and the like. In some implementations, the database 140 may further include data to be analyzed by the trainer 130 using machine learning models trained as described herein.

It should be noted that FIG. 1 depicts an example network diagram 100, but that the disclosed embodiments are not limited to the network environment 100 depicted in FIG. 1.

An example process which may be performed in accordance with the setup shown in the network diagram 100 is now discussed. A system (e.g., the trainer 130, FIG. 1) is taught a wide range of custom concepts that are applicable to different use-cases such as, but not limited to, in compliance, governance, litigation, investigation, and general corporate data management. Knowledge is queried, including concepts that were previously taught by other users of the system. Natural language interactions are received, thereby enabling users to teach and query knowledge through mixed-initiative natural language dialogue, as well as communicate meta-knowledge and tasks related to the system itself, such as its performance. Machine learning models trained as part of the teachings are applied.

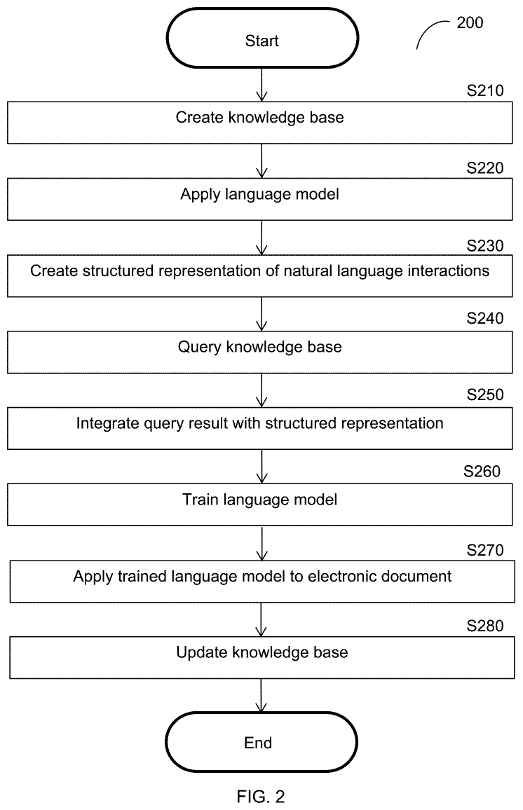

FIG. 2 is an example flowchart 200 flowchart illustrating a method for training machine learning models using natural language interactions according to an embodiment. In an embodiment, the method is performed by the trainer 130, FIG. 1.

At S210, a knowledge base is created based on a dataset associated with a set of files. In an embodiment, the knowledge base indicates a plurality of entities and a plurality of relationships between entities of the plurality of entities indicated among the set of files.

At S220, a language model is applied to a set of natural language interactions in order to output a set of domain-specific language (DSL) data. In an embodiment, the set of natural language interactions is between a user and at least one other entity (e.g., an artificial intelligence assistant). The set of natural language interactions indicates at least one user-defined concept, that is, the user communicates concepts that they would like to teach a system during the natural language interactions.

In an embodiment, the natural language interactions indicate at least one specification for the at least one user-defined concept. The specification natural language interactions include interactions where users can submit specifications through a conversational chat interface or by submitting a document containing the specifications, such as a document review protocol or an internal rulebook.

In another embodiment, the natural language interactions include at least one natural language query. During natural language query interactions, users can submit natural language queries in the form of questions. These questions may include or be related to facts in the data, document queries, concept queries, and meta-queries.

At S230, a structured representation of the set of natural language interactions is created. In an embodiment, the structured representation includes a set of fields and corresponding values, wherein the values in the structured representation include values represented in the natural language interactions.

At S240, a knowledge base is queried based on the set of DSL data in order to obtain at least one DSL query result. In an embodiment, querying the knowledge base includes translating the at least one natural language query into at least one domain-specific language (DSL) query formatted according to a domain-specific language of the knowledge base. In an embodiment, the at least one DSL query result indicates at least one of the plurality of entities.

At S250, the at least one DSL query result is integrated with the structured representation of the natural language interactions in order to create at least one contextualized DSL query result.

At S260, the language model is trained using the at least one contextualized DSL query result. In an embodiment in which the natural language interactions included one or more references to electronic documents, the language model is trained using the contextualized DSL query results and those electronic documents. In this regard, the language model may be refined to recognize the user-defined concepts indicated in the natural language interactions within electronic documents.

At S270, the trained language model is applied to at least one electronic document in order to identify at least one of the at least one user-defined concept in the at least one electronic document.

At S280, the knowledge base is updated on at least a portion of the natural language interactions. In an embodiment, updating the knowledge base includes adding a representation of a new entity indicated in the portion of the natural language interactions. In a further embodiment, the representation of the new entity added to the knowledge base is expressed in the domain-specific language.

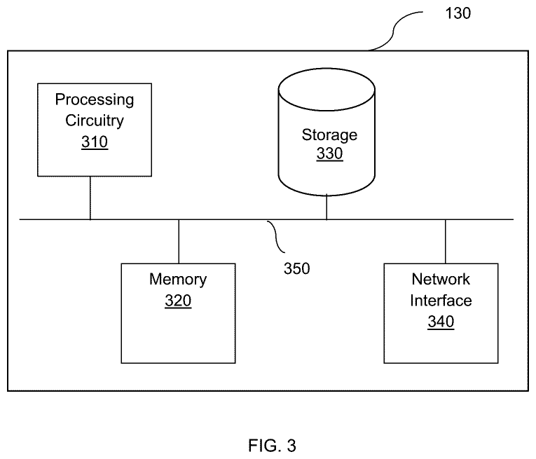

FIG. 3 is an example schematic diagram of the trainer 130 according to an embodiment. The trainer 130 includes a processing circuitry 310 coupled to a memory 320, a storage 330, and a network interface 340. In an embodiment, the components of the trainer 130 may be communicatively connected via a bus 350.

The processing circuitry 310 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 320 may be volatile (e.g., random access memory, etc.), non-volatile (e.g., read only memory, flash memory, etc.), or a combination thereof.

In one configuration, software for implementing one or more embodiments disclosed herein may be stored in the storage 330. In another configuration, the memory 320 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 310, cause the processing circuitry 310 to perform the various processes described herein.

The storage 330 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 340 allows the trainer 130 to communicate with, for example, the user device 120, the databases 140, and the like.

It should be understood that the embodiments described herein are not limited to the specific architecture illustrated in FIG. 3, and other architectures may be equally used without departing from the scope of the disclosed embodiments.

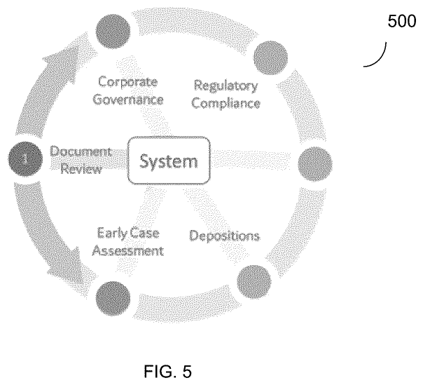

The disclosed embodiments may be utilized to realize a new workflow, for example, the workflow depicted in the illustration 500, FIG. 5. As contrasted with a linear workflow, the workflow depicted in FIG. 5 demonstrates how the system allows for unifying inputs from users across various parts of a non-limiting example use case process such as the legal process represented in the illustration 500.

Various disclosed embodiments allow for the natural mixing of multiple concepts and teaching strategies, enabling users to effectively address a wide range of practical business use-cases. For example, a user may combine previously taught concepts and teaching strategies, such as providing both an explanation and an example.

FIG. 6 depicts a non-limiting example diagram 600 of a systems flow illustrating a cycle of updating specifications and queries in which new specifications update system knowledge which, when new queries are received from users, allows for updating the specifications, and so on. As depicted in FIG. 6 new specifications among a set of natural language (NL) specifications 610 may be utilized to update knowledge of the system, which in turn may lead to new natural language queries 620 from users, which in turn may lead to updating the specifications.

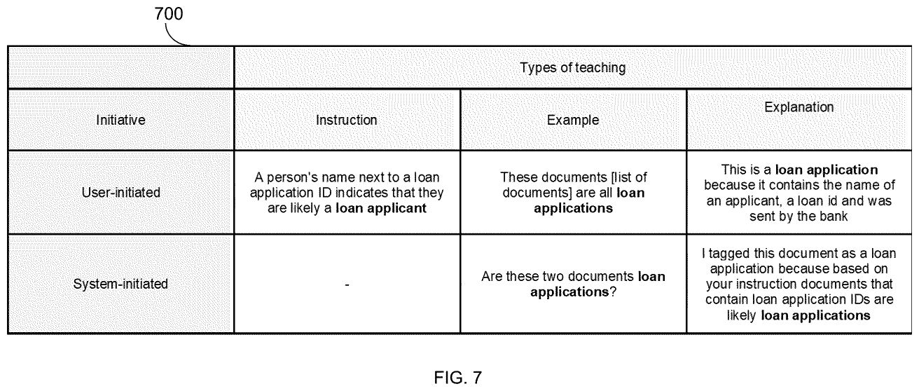

FIG. 7 is a non-limiting example table 700 illustrating some example user-initiated and system-initiated teachings such as, but not limited to, instructions, examples, and explanations.

The disclosed embodiments may be utilized to facilitate and enable users to effectively teach machine learning models through natural language interactions. More specifically, user inputs in the form of natural language samples such as text, audio, and the like, are utilized as training data used to train machine learning models. The natural language interactions may be facilitated by one or more large language models (LLMs) in order to enable a user to interact with the trainer system training the models in order to collect training data through an intuitive process which does not require explicit programming and can achieve comparable performance with a lower amount of training data as compared to at least some existing solutions.

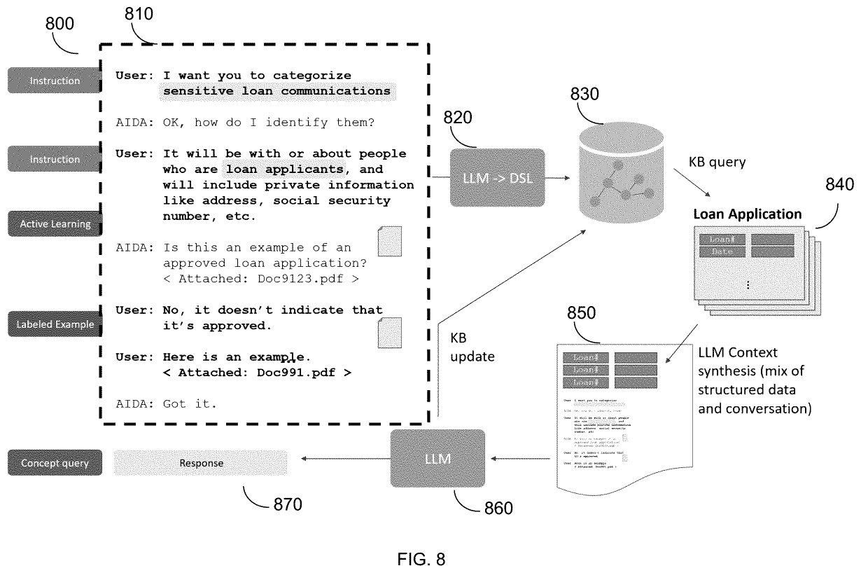

FIG. 8 is an example diagram 800 illustrating a data flow for a process of training a machine learning model using natural language interactions which demonstrates an example natural language interaction between a user and an artificial intelligence system.

As shown in FIG. 8, a natural language interaction session 810 is input as a set of text representing the natural language interactions to a natural language processing component and then to a domain-specifical language (DSL) component in order to translate 820 the text 810 from a natural language into domain-specifical language data representing at least a portion of the natural language interactions in a domain-specific language format. In the example implementation shown in FIG. 8, the natural language processing component is a large language model (LLM). The domain-specific language data is utilized to generate a query and to query 830 a knowledge base using the DSL interactions data in order to produce a DSL query result. The DSL query results are inserted into a data structure for the natural language interactions, thereby creating a structured representation of at least a portion of the natural language interactions.

The knowledge base query result 840 is synthesized in a context synthesis process 850. The context synthesis process 850 integrates the result 840 of querying the knowledge base using the domain-specific language with the structured representation of the at least a portion of the natural language interactions. In the example implementation shown in FIG. 8, the context synthesis process 850 is a LLM context synthesis process.

The result of the context synthesis 850 may be used to train 860 a language model such as a LLM (e.g., a generative pre-trained transformer, or GPT, model) of the natural language processing component. The trained language model may be queried, and query results of the language model may be utilized to update the knowledge base, to provide a response 870 to a user query, or both.

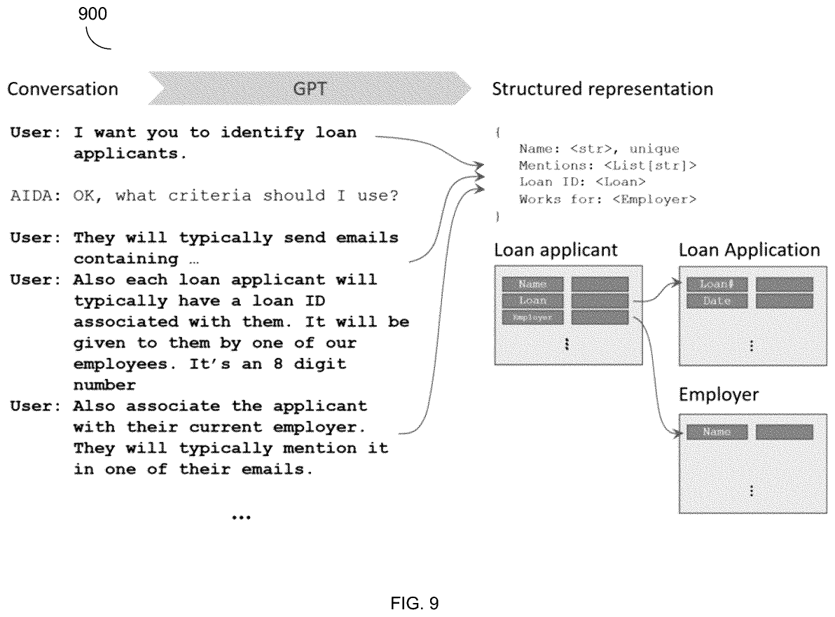

FIG. 9 is an example diagram 900 illustrating creation of a structured representation via such a natural language interaction.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for training a machine learning model using natural language interactions, comprising:
applying a language model to text of a set of natural language interactions in order to output a set of domain-specific language (DSL) data, wherein the set of natural language interactions is between a user and at least one other entity, wherein the set of natural language interactions indicates at least one user-defined concept;
querying a knowledge base based on the set of DSL data in order to obtain at least one DSL query result;
integrating the at least one DSL query result with a structured representation of the natural language interactions in order to create at least one contextualized DSL query result; and
training the language model using the at least one contextualized DSL query result.

2. The method of claim 1, further comprising:
creating the structured representation of the set of natural language interactions, wherein the structured representation includes a set of fields and corresponding values, wherein the values in the structured representation include values represented in the natural language interactions.

3. The method of claim 1, further comprising:
creating the knowledge base based on a dataset associated with a set of files, wherein the created knowledge base indicates a plurality of entities and a plurality of relationships between entities of the plurality of entities indicated among the set of files.

4. The method of claim 3, wherein the at least one contextualized DSL query result indicates at least one of the plurality of entities.

5. The method of claim 1, further comprising:
updating the knowledge base on at least a portion of the natural language interactions, wherein updating the knowledge base includes adding a representation of a new entity indicated in the portion of the natural language interactions.

6. The method of claim 5, wherein the representation of the new entity added to the knowledge base is expressed in the domain-specific language.

7. The method of claim 1, wherein the natural language interactions indicate at least one specification for the at least one user-defined concept.

8. The method of claim 1, wherein the natural language interactions include at least one natural language query.

9. The method of claim 1, further comprising:
applying the trained language model to at least one electronic document in order to identify at least one of the at least one user-defined concept in the at least one electronic document.

10. A non-transitory computer readable medium having stored thereon instructions for causing a processing circuitry to execute a process, the process comprising:
applying a language model to text of a set of natural language interactions in order to output a set of domain-specific language (DSL) data, wherein the set of natural language interactions is between a user and at least one other entity, wherein the set of natural language interactions indicates at least one user-defined concept;
querying a knowledge base based on the set of DSL data in order to obtain at least one DSL query result;
integrating the at least one DSL query result with a structured representation of the natural language interactions in order to create at least one contextualized DSL query result; and
training the language model using the at least one contextualized DSL query result.

11. A system for training a machine learning model using natural language interactions, comprising:
a processing circuitry; and
a memory, the memory containing instructions that, when executed by the processing circuitry, configure the system to:
apply a language model to text of a set of natural language interactions in order to output a set of domain-specific language (DSL) data, wherein the set of natural language interactions is between a user and at least one other entity, wherein the set of natural language interactions indicates at least one user-defined concept;
query a knowledge base based on the set of DSL data in order to obtain at least one DSL query result;
integrate the at least one DSL query result with a structured representation of the natural language interactions in order to create at least one contextualized DSL query result; and
train the language model using the at least one contextualized DSL query result.

12. The system of claim 11, wherein the system is further configured to:
create the structured representation of the set of natural language interactions, wherein the structured representation includes a set of fields and corresponding values, wherein the values in the structured representation include values represented in the natural language interactions.

13. The system of claim 11, wherein the system is further configured to:
create the knowledge base based on a dataset associated with a set of files, wherein the created knowledge base indicates a plurality of entities and a plurality of relationships between entities of the plurality of entities indicated among the set of files.

14. The system of claim 13, wherein the at least one contextualized DSL query result indicates at least one of the plurality of entities.

15. The system of claim 11, wherein the system is further configured to:
update the knowledge base on at least a portion of the natural language interactions, wherein updating the knowledge base includes adding a representation of a new entity indicated in the portion of the natural language interactions.

16. The system of claim 15, wherein the representation of the new entity added to the knowledge base is expressed in the domain-specific language.

17. The system of claim 11, wherein the natural language interactions indicate at least one specification for the at least one user-defined concept.

18. The system of claim 11, wherein the natural language interactions include at least one natural language query.

19. The system of claim 11, wherein the system is further configured to:
apply the trained language model to at least one electronic document in order to identify at least one of the at least one user-defined concept in the at least one electronic document.

20. The system of claim 11, wherein the system further comprises:
the knowledge base (KB) storing entities, relations, and concepts;
a natural language processing (NLP) component configured to translate the at least one natural language query into the at least one DSL query, wherein the natural language processing component includes the natural language processing model;
a structured domain-specific language (DSL) component configured to query the knowledge base using the at least one DSL query; and
a synthesis component configured to integrate the at least one knowledge base query result with the structured representation of the natural language interactions.
